(19) United States
(12) Patent Application Publication
(10) Pub. No.: US 2007/0122677 A1
(43) Pub. Date: May 31, 2007

(54) Fuel cell system

(75) Inventors: Myung-Seok PARK, Gyeonggi-Do (KR); Seong-Geun HEO, Gyeonggi-Do (KR)

Correspondence Address: GREENBLUM & BERNSTEIN, P.L.C., 1950 ROLAND CLARKE PLACE, RESTON, VA, 20191, US

(73) Assignees: LG ELECTRONICS INC., Seoul (KR); LG CHEM, LTD., Seoul (KR)

(21) Appl. No.: 11/548,773

(22) Filed: Oct. 12, 2006

(30) Foreign Application Priority Data
Nov. 29, 2005 (KR) 10-2005-0115143

(51) Int. Cl. H01M 8/24; H01M 8/04

(52) U.S. Cl. 429/34; 429/26

(57) ABSTRACT

A fuel cell system includes a stack unit that generates electricity by electrochemically reacting hydrogen and air; a fuel supply unit that supplies hydrogen to the stack unit; an air supply unit that supplies air to the stack unit; and a module unit having a used gas line that exhausts used gas generated from the fuel supply unit, having a fuel supply line that supplies hydrogen provided from the fuel supply unit to the stack unit, and having an air supply line that supplies air provided from the air supply unit to the stack unit, in which the used gas line, the fuel supply line, and the air supply line are sequentially arranged and integrally modularized. Hydrogen and air each having a required temperature from the stack unit are supplied to the stack unit, thereby improving thermal efficiency of the fuel cell system.

### CROSS REFERENCE TO RELATED APPLICATIONS

The present disclosure relates to subject matter contained in priority Korean Application No. 10-2005-0115143, filed on Nov. 29, 2005, which is herein expressly incorporated by reference in its entirety.

### BACKGROUND OF THE INVENTION

1. Field of the Invention

The present invention relates to a fuel cell system, and more particularly, to a fuel cell system that supplies hydrogen and air having a proper temperature to a stack unit.

2. Description of the Related Art

FIG. 1 is a schematic view showing each component of a fuel cell system in accordance with the related art. Referring to FIG. 1, the related art fuel cell system 10 includes a reformer 12 for supplying hydrogen to a stack 11; a gas-liquid separation unit 13 for removing moisture included in hydrogen supplied to the stack 11; a heat exchanger 14 for heat-exchanging heat generated from the stack 11; and a humidifier 15 for humidifying air supplied to the stack 11.

The stack 11 is formed accordingly as a plurality of cells each including an electrode and an electrolyte for electricity generation laminated together. The stack 11 is very temperature sensitive. Since the electrochemical reaction speed between hydrogen and air varies according to the temperature of the stack 11, the stack 11 has to maintain a proper temperature, taking into consideration the durability of the cell. For instance, in a Proton Exchange Membrane Fuel Cell (PEMFC) using only hydrogen as a fuel, the stack 11 has to have a proper temperature of 50°C.˜80°C. Accordingly, the heat exchanger 14 boosts the temperature of air and hydrogen.

The gas-liquid separation unit 13 removes moisture in hydrogen so as to provide air having a the proper moisture content to the stack 11, and the humidifier 15 provides moisture to the air.

As shown in FIG. 1, the related art fuel cell system includes a reformer 12, a gas-liquid separation unit 13, a heat exchanger 14, and a humidifier 15. The components of the fuel cell system are individually installed and connected to one another by pipes. While hydrogen and air are supplied to the stack 11 via the reformer 12, the gas-liquid separation unit 13, the heat exchanger 14, the humidifier 15, and the pipes, temperatures thereof are greatly varied and a pressure/flow loss thereof occurs.

Accordingly, hydrogen and air each having a proper temperature are not smoothly supplied to the stack 11, and thus an optimum electrochemical reaction is not performed in the stack 11.

Also, while hydrogen and air pass through the reformer 12, the gas-liquid separation unit 13, the heat exchanger 14, the humidifier 15, and the pipes, thermal loss thereof is increased, thus degrading thermal efficiency of the fuel cell system

Furthermore, since the reformer 12, the gas-liquid separation unit 13, the heat exchanger 14, the humidifier 15, and the pipes are individually installed, the entire volume of the fuel cell system is increased. When the components are individually produced, mass production of the fuel cell system is degraded.

### SUMMARY OF THE INVENTION

The present invention is provided to address at least the above described problems in the art. Therefore, an object of the present invention is to provide a fuel cell system capable of supplying hydrogen and air, each having a proper temperature, to a stack unit.

Another object of the present invention is to provide a fuel cell system capable of increasing-thermal efficiency.

A further object of the present invention is to provide a fuel cell system having a decreased volume and improved mass production capability.

To achieve these and other advantages and in accordance with the purpose of the present invention, as embodied and broadly described herein, an aspect of the present invention provides a fuel cell system, including a stack unit that generates electricity by electrochemically reacting hydrogen and air; a fuel supply unit that supplies hydrogen to the stack unit; an air supply unit that supplies air to the stack unit; and a module unit having a used gas line that exhausts used gas generated from the fuel supply unit, a fuel supply line that supplies hydrogen provided from the fuel supply unit to the stack unit, and an air supply line that supplies air provided from the air supply unit to the stack unit, the used gas line, the fuel supply line, and the air supply line being sequentially arranged and integrally modularized. A further aspect of the present invention provides a fuel supply line positioned at a lower side of the used gas line, and the air supply line is positioned at a lower side of the fuel supply line. Further, the used gas line is positioned at a center, the fuel supply line surrounds an outer circumferential surface of the used gas line, and the air supply line surrounds an outer circumferential surface of the fuel supply line. The modular unit may further include a first gas-liquid separation unit positioned adjacent to the used gas line, said first gas-liquid separation unit configured to remove moisture contained in hydrogen supplied to the stack unit from the fuel supply unit; a second gas-liquid separation unit positioned adjacent to the first gas-liquid separation unit, said second gas-liquid separation unit configured to moisture contained in off-gas supplied to the fuel supply unit from the stack unit; a first recollect line provided between the used gas line and the first gas-liquid separation unit; and a second recollect line provided between the first gas-liquid separation unit and the second gas-liquid separation unit. The module unit may further include a heat exchanger positioned adjacent to the used gas line, said heat exchanger configured to exchange heat generated by the stack unit. The module unit may further include a first gas-liquid separation unit positioned adjacent a left side of the used gas line, said first gas-liquid separation unit configured to remove moisture contained in hydrogen supplied to the stack unit from the fuel supply unit; a second gas-liquid separation unit positioned adjacent a left side to the first gas-liquid separation unit, said second gas-liquid unit configured to remove moisture contained in off-gas supplied to the fuel supply unit from the stack unit; a heat exchanger positioned adjacent a right side of the used gas line, said heat exchanger configured to exchanged heat generated by the stack unit; a first recollect line provided between the used gas line and the first gas-liquid separation unit; and a second recollect line provided between the first gas-liquid separation unit and the second gas-liquid separation unit, wherein the fuel supply line is positioned adjacent a lower side of the used gas line, and the air supply line is positioned adjacent a lower side of the fuel supply line.

A further aspect of the present invention provides a fuel cell system, including a stack unit that generates electricity by electrochemically reacting hydrogen and air; a fuel supply unit that supplies hydrogen to the stack unit; an air supply unit that suppliesair to the stack unit; and a module unit having a used gas line that exhausts used gas generated from the fuel supply unit, a fuel supply line positioned adjacenta lower side of the used gas line that supplies hydrogen provided from the fuel supply unit to the stack unit, an air supply line positioned adjacent a lower side of the fuel supply line that supplies air provided from the air supply unit to the stack unit, and a heat exchanger closely arranged to the used gas line for exchanging heat generated from the stack unit, wherein the used gas line, the fuel supply line, the air supply line, and the heat exchanger are integrally modularized. Further, the module unit may further include a first gas-liquid separation unit positioned adjacent to the used gas line, that removes moisture contained in hydrogen supplied to the stack unit from the fuel supply unit; a second gas-liquid separation unit positioned adjacent to the first gas-liquid separation unit, that removes moisture contained in off-gas supplied to the fuel supply unit from the stack unit; a first recollect line provided between the used gas line and the first gas-liquid separation unit; and a second recollect line provided between the first gas-liquid separation unit and the second gas-liquid separation unit.

A further aspect of the present invention provides a fuel cell system, including a stack unit that generates electricity by electrochemically reacting hydrogen and air; a fuel supply unit that supplies hydrogen to the stack unit; an air supply unit that supplies air to the stack unit; and a module unit having a used gas line that exhausts used gas generated from the fuel supply unit, a fuel supply fine that surrounds an outer circumferential surface of the used gas line that supplies hydrogen provided from the fuel supply unit to the stack unit, an air supply line that surrounds an outer circumferential surface of the fuel supply line that supplies air provided from the air supply unit to the stack unit, and a heat exchanger positioned adjacent to the used gas line that exchanges heat generated from the stack unit, wherein the used gas line, the fuel supply line, the air supply line, and the heat exchanger are integrally modularized. Further, the module unit may further include a first gas-liquid separation unit positioned adjacent to the used gas line, that removes moisture contained in hydrogen supplied to the stack unit from the fuel supply unit; a second gas-liquid separation unit positioned adjacent to the first gas-liquid separation unit, that removes moisture contained in off-gas supplied to the fuel supply unit from the stack unit; a first recollect line provided between the used gas line and the first gas-liquid separation unit; and a second recollect line provided between the first gas-liquid separation unit and the second gas-liquid separation unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The above, and other objects, features, and advantages of the present invention will be made apparent form the following description of the preferred embodiments, given as nonlimiting examples, with reference to the accompanying drawings in which:

FIG. 1 is a schematic view showing each component of a fuel cell system in accordance with the related art;

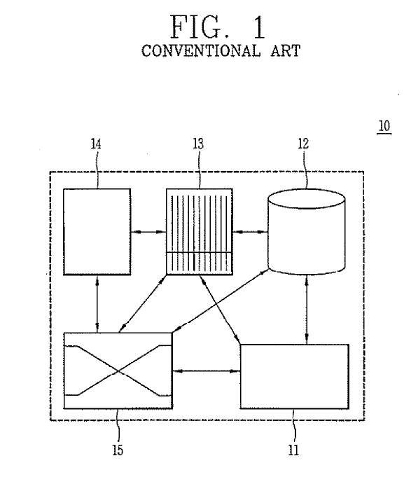

FIG. 2 is a block diagram showing a fuel cell system according to an embodiment of the present invention,

FIG. 3 is a view showing a module unit of the embodiment of FIG. 2;

FIG. 4 is a view showing a first variation of the module unit of the embodiment of FIG. 2, including first and second gas-liquid separation units and first and second recollect lines;

FIG. 5 is a view showing a second variation of the module unit of the embodiment of FIG. 2. further including a heat exchanger; and

FIG. 6 is a view showing a third variation of the module unit of the embodiment of FIG. 2, further including first and second gas-liquid separation units, first and second recollect lines, and a heat exchanger.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

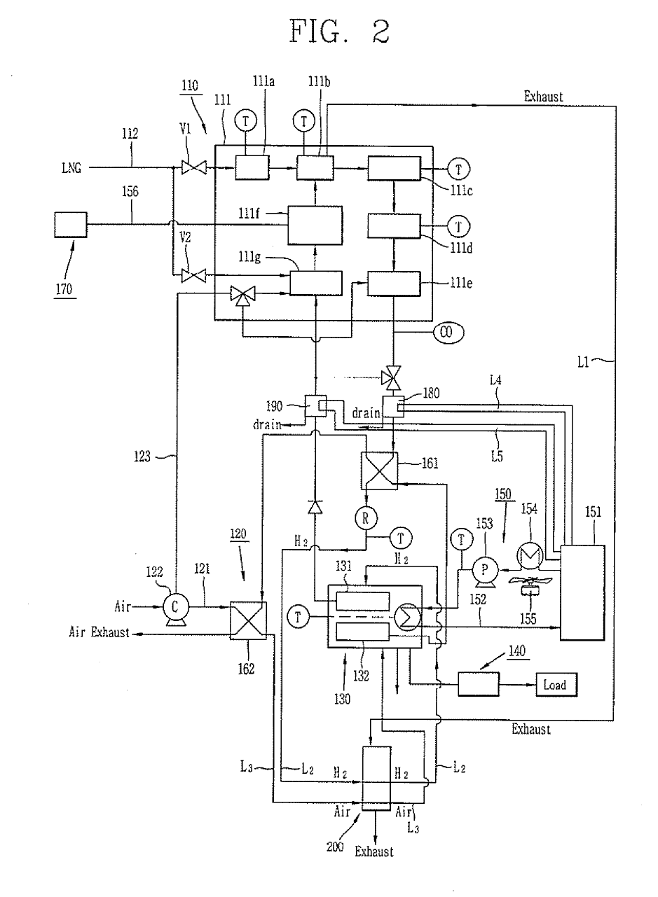

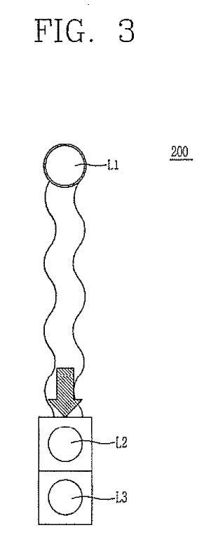

Hereinafter, a fuel cell system according to an embodiment of the present invention will be explained in more detail with reference to the attached drawings. FIG. 2 is a block diagram showing a fuel cell system according to an embodiment of the present invention, and FIG. 3 is a view showing a module unit of the embodiment of FIG. 2.

Referring to FIG. 2, the fuel cell system according to an embodiment of the present invention includes a fuel supply unit 110, an air supply unit 120, a stack unit 130, an electricity output unit 140, a water supply unit 150, a warm water supply unit 170, a first gas-liquid separation unit 180, a second gas-liquid separation unit 190, and a module unit 200.

The fuel supply unit 110 includes a reformer 111 for refining hydrogen from LNG thus supplying the hydrogen to an anode 131 of the stack unit 130, and a pipe 112 for supplying LNG to the reformer 111. The reformer 111 includes a desulfurizing reactor 111a for removing sulfur contained in a fuel, a steam reformer 111b for generating hydrogen by reforming a fuel and steam, a high temperature steam reformer 111c and a low temperature steam reformer 111d, respectively, for additionally generating hydrogen by re-acting carbon monoxide generated after passing through the steam reformer 111b, a partial oxidation reactor 111e for refining hydrogen by removing carbon monoxide included in fuel by using air as a catalyst, a steam generator 111f for supplying steam to the steam reformer 111b, and a burner 111g for supplying heat to the steam generator 111f.

Used gas generated from the reformer 111 is supplied to a module unit 200 through a used gas line L1. Also, hydrogen generated from the reformer 111 is supplied to a stack unit 130 through a fuel supply line L2 after passing the module unit 200.

The air supply unit 120 includes a first air supply line 121, a second air supply line 123, and an air supply fan 122. The first air supply line 121 is provided between the air supply fan 122 and a second pre-heater 162 so as to supply atmospheric air to a cathode 132. The second air supply line 123 is provided between the air supply fan 122 and the burner 111g so as to supply atmospheric air to the burner 111g. Air exhausted from the second pre-heater 162 is supplied to the module unit 200 through an air supply line L3.

The stack unit 130 includes the anode 131 and the cathode 132 for generating both electric energy and thermal energy by an electrochemical reaction between hydrogen and oxygen, respectively, supplied from the fuel supply unit 110 and the air supply unit 120. Hydrogen having passed the module unit 200 is supplied to the anode 131, and air having passed the module unit 200 is supplied to the cathode 132.

The electricity output unit 140 converts electrical energy generated from the stack unit 130 into an alternating current thus to supply it to a load.

The water supply unit 150 supplies water to the stack unit 130 of the fuel supply unit 110 to cool the stack unit 130. The water supply unit 150 includes a water supply container 151 for containing a certain amount of water, a water circulation line 152 for connecting the stack unit 130 and the water supply container 151 to each other, a water supply pump 153 provided at a middle portion of the water circulation line 152 for pumping water of the water supply container 151, and a heat exchanger 154 and a heat emission fan 155 provided at a middle portion of the water circulation line 152 for cooling supplied water.

A first recollect line L4 for accelerating an operation of the first gas-liquid separation unit 180 is provided between the water supply unit 150 and the first gas-liquid separation unit 180, and a second recollect line L5 for accelerating an operation of the second gas-liquid separation unit 190 is provided between the water supply unit 150 and the second gas-liquid separation unit 190. More particularly, the first recollect line L4 is provided to penetrate inside of the first gas-liquid separation unit 180. Moisture contained in hydrogen inside the first gas-liquid separation unit 180 is condensed by cooling water of the water supply unit 150 flowing on the first recollect line L4, and is then drained outwardly. The second recollect line L5 is provided to penetrate inside of the second gas-liquid separation unit 190. Moisture contained in off-gas inside the second gas-liquid separation unit 190 is condensed by cooling water of the water supply unit 150 flowing on the second recollect line L5, and is then drained outwardly.

The warm water supply unit 170 supplies stored warm water to the steam generator 111f through a pipe 156.

The first gas-liquid separation unit 180 is provided between the fuel supply unit 110 and the stack unit 130, thereby removing moisture contained in hydrogen supplied to the stack unit 130 from the fuel supply unit 110. Details of the moisture removal were described with reference to the first recollect line L4, and thus a detailed explanation thereof will be omitted here.

The second gas-liquid separation unit 190 is provided between the fuel supply unit 110 and the stack unit 130, thereby removing moisture contained in off-gas supplied to the fuel supply unit 110 from the stack unit 130. Details of the moisture removal were described with reference to the second recollect line L5, and thus a detailed explanation thereof will be omitted here.

FIG. 3 is a view showing a module unit of the embodiment of FIG. 2, in which the thick arrow indicates the heat transfer direction.

Referring to FIG. 3, the module unit 200 includes a used gas line L1 for exhausting used gas generated from the fuel supply unit 110, a fuel supply line L2 closely arranged at a lower side of the used gas line L1 for supplying hydrogen supplied from the fuel supply unit 110 to the stack unit 130, and an air supply line L3 closely arranged at a lower side of the fuel supply line L2 for supplying air supplied from the air supply unit 120 to the stack unit 130. The used gas line L1, the fuel supply line L2, and the air supply line L3 are integrally formed as one module. The used gas line L1, the fuel supply line L2, and the air supply line L3 can be integrally modularized by various methods such as, for example, a screw coupling, a bonding, a or welding.

In another example, the used gas line L1, the fuel supply line L2, and the air supply line L3 are arranged coaxially such that the used gas line L1 is arranged at the center, the fuel supply line L2 is arranged to surround and cover an outer circumferential surface of the used gas line L1, and the air supply line L3 is arranged to surround and cover an outer circumferential surface of the fuel supply line L2.

The fuel supply line L2 is closely arranged at a lower side of the used gas line L1 to receive the heat of used gas. Accordingly, hydrogen inside the fuel supply line L2 has an increased temperature, and is supplied to the stack unit 130. The used gas line L1 has a curved shape so as to accelerate thermal diffusion of used gas having a high temperature inside the used gas line L1.

The air supply line L3 is closely arranged at a lower side of the fuel supply line L2 to receive the heat of hydrogen inside the fuel supply line L2. Accordingly, air inside the air supply line L3 has an increased temperature, and is supplied to the stack unit 130.

The arrangement of the used gas line L1, the fuel supply line L2, and the air supply line L3 as shown in FIG. 3 will be explained in more detail below.

The fuel supply line L2 is closely arranged at a lower side of the used gas line L1 so that heat of used gas having a high temperature flowing in the used gas line L1 can be initially transmitted to hydrogen inside the fuel supply line L2, the temperature of the hydrogen being required to be-greatly increased to 50° C.-80° C. The air supply line L3 is closely arranged at a lower side of the fuel supply line L2 so that heat of hydrogen inside the fuel supply line L2 can be secondarily transmitted to air inside the air supply line L3, the temperature of the air requiring a small increase.

As the used gas line L1, the fuel supply line L2, and the air supply line L3 are integrally formed as the module unit 200, hydrogen and air each having a required temperature from the stack unit 130 can be supplied to the stack unit 130. Accordingly, thermal efficiency of the fuel cell system is enhanced and improved. Further, heat of used gas exhausted through the used gas line L1 is utilized to enhance the thermal efficiency of the fuel cell system.

Hereinafter, the construction and-operation of a module unit according to another embodiment of the present invention will be explained.

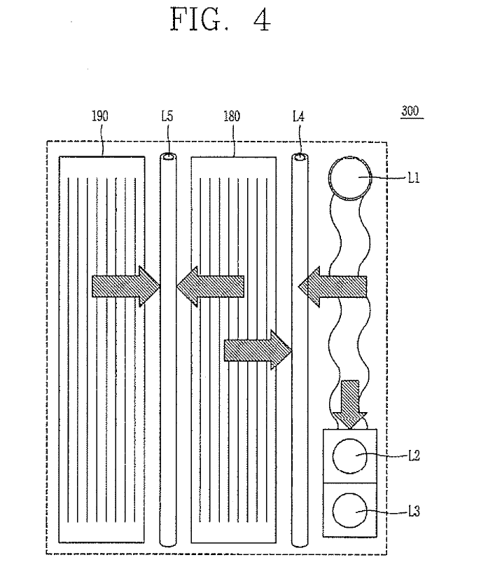

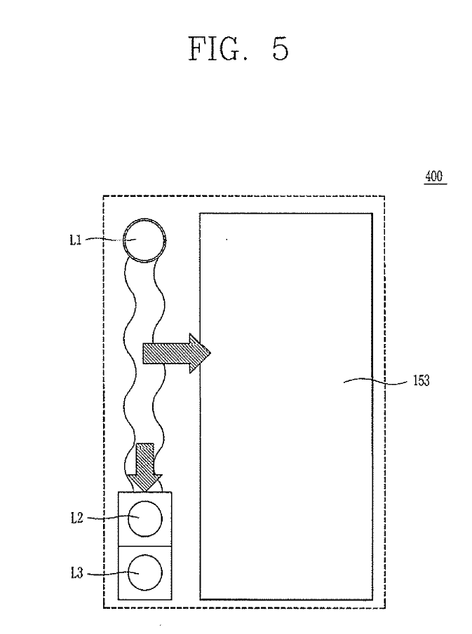

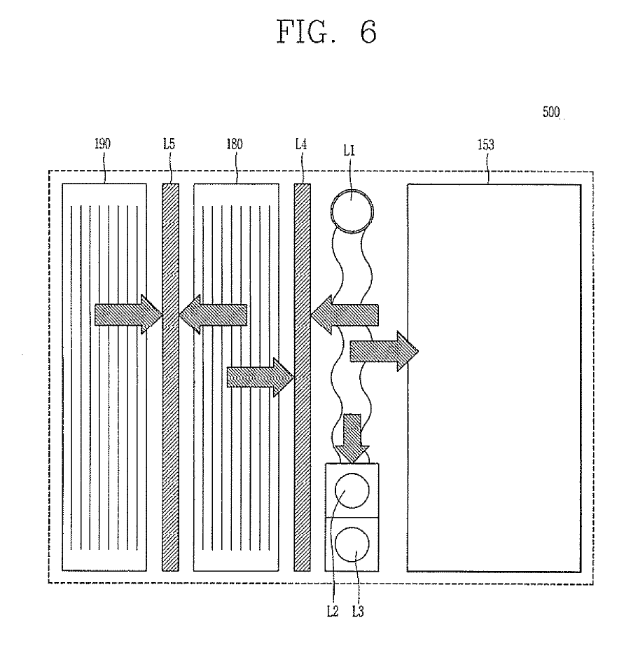

FIG. 4 is a view showing a first variation of the module unit of the embodiment of FIG. 2, the module unit further including first and second gas-liquid separation units and first and second recollect lines, FIG. 5 is a view showing a second variation of the module unit of the embodiment of FIG. 2, the module unit further including a heat exchanger; and FIG. 6 is a view showing a third variation of the module unit of the embodiment of FIG. 2, the module unit further including the first and second gas-liquid separation units, the first and second recollect lines, and the heat exchanger.

Referring to FIGS. 2 and 4, a module unit 300 includes a used gas line L1 for exhausting used gas generated from the fuel supply unit 110, a fuel supply line L2 closely arranged at a lower side of the used gas line L1 for supplying hydrogen supplied from the fuel supply unit 110 to the stack unit 130, an air supply line L3 closely arranged at a lower side of the fuel supply line L2 for supplying air supplied from the air supply unit 120 to the stack unit 130, a first gas-liquid separation unit 180 closely arranged at a left side of the used gas line L1, a second gas-liquid separation unit 190 closely arranged at a left side of the first gas-liquid separation unit 180, a first recollect line L4 arranged between the used gas line L1 and the first gas-liquid separation unit 180, and a second recollect line L5 arranged between the first gas-liquid separation unit 180 and the second gas-liquid separation unit 190.

Hydrogen and air each having a requested temperature from the stack unit 130 can be supplied to the stack unit 130 by the module unit 300, and thus thermal efficiency of the fuel cell system is enhanced and improved. Further, heat of used gas exhausted through the used gas line L1 is utilized thus to enhance the thermal efficiency of the fuel cell system. Moreover, heat inside the used gas line L1 is transferred to the first gas-liquid separation unit 180 and the second gas-liquid separation unit 190, thereby maintaining a proper temperature for gas-liquid separation.

Referring to FIGS. 2 and 5, a module unit 400 includes a used gas line L1 for exhausting used gas generated from the fuel supply unit 110, a fuel supply line L2 closely arranged at a lower side of the used gas line L1 for supplying hydrogen supplied from the fuel supply unit 110 to the stack unit 130, an air supply line L3 closely arranged at a lower side of the fuel supply line L2 for supplying air supplied from the air supply unit 120 to the stack unit 130, and a heat exchanger 153 closely arranged at a right side of the used gas line L1 for exchanging heat generated from the stack unit 130. Herein, the heat exchanger 153 may be arranged at a left side or at an upper side of the used gas line L1.

Hydrogen and air each having a requested temperature from the stack unit 130 can be supplied to the stack unit 130 by the module unit 400, and thus thermal efficiency of the fuel cell system is enhanced and improved. Further, heat of used gas exhausted through the used gas line L1 is utilized thus to enhance the thermal efficiency of the fuel cell system. Moreover, heat inside the used gas line is transferred to the heat exchanger 153 thus to utilize heat of used gas.

Referring to FIGS. 2 and 6, a module unit 500 includes a used gas line L1 for exhausting used gas generated from the fuel supply unit 110, a fuel supply line L2 closely arranged at a lower side of the used gas line L1 for supplying hydrogen supplied from the fuel supply unit 110 to the stack unit 130, an air supply line L3 closely arranged at a lower side of the fuel supply line L2 for supplying air supplied from the air supply unit 120 to the stack unit 130, a first gas-liquid separation unit 180 closely arranged at a left side of the used gas line L1, a second gas-liquid separation unit 190 closely arranged at a left side of the first gas-liquid separation unit 180, a first recollect line L4 arranged between the used gas line L1 and the first gas-liquid separation unit 180, a second recollect line L5 arranged between the first gas-liquid separation unit 180 and the second gas-liquid separation unit 190, and a heat exchanger 153 closely arranged at a right side of the used gas line L1 for exchanging heat generated from the stack unit 130.

Hydrogen and air each having a required temperature from the stack unit 130 can be supplied to the stack unit 130 by the module unit 500, and thus thermal efficiency of the fuel cell system is enhanced and improved. Further, heat of used gas exhausted through the used gas line L1 is utilized thus to enhance the thermal efficiency of the fuel cell system. Moreover, heat inside the used gas line is transferred to the first gas-liquid separation unit 180 and the second gas-liquid separation unit 190, thereby maintaining a proper temperature for gas-liquid separation. Furthermore, heat inside the used gas line L1 is transferred to the heat exchanger 153 thus to utilize heat of used gas.

As described above, the fuel cell system according to the present invention is provided with the module unit formed as the used gas line, the fuel supply line, and the air supply line are integrally modularized. Accordingly, hydrogen and air each having a required temperature from the stack unit are supplied to the stack unit, thereby enhancing a thermal efficiency of the fuel cell system.

Additionally, heat of used gas exhausted through the used gas line is utilized thus to enhance the thermal efficiency of the fuel cell system.

Further, the fuel cell system has a decreased volume owing to the modularization of each component, thereby having an enhanced and improved capability of mass production, providing additional associated benefits to the system, Also, the entire fabrication cost of the fuel cell system is reduced due to a short length of the pipe.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

Although the embodiments of the present invention have been described herein with reference to the accompanying drawings, many modifications and changes may be made by those skilled in the art without departing from the scope of the invention.

It is further noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials, and embodiments, the present invention is not intended to be limited to the particulars disclosed herein; rather the present invention extends to all functionally equivalent structure, methods, and uses, such as are within the scope of the appended claims.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. As the present invention may be embodied in several forms without departing from the spirit or essential characteristics thereof, it should also be understood that the above described embodiments are not limited by any of the details of the foregoing description, unless other specified. Rather, the above described embodiments should be construed broadly within the spirit and scope of the present invention as defined in the appended claims. Therefore, changes my be made within the metes and bounds of the appended claims, as presently stated and as amended, without departing from the scope and spirit of the invention in its aspects.

What is claimed is:

1. A fuel cell system, comprising:
a stack unit that generates electricity by electrochemically reacting hydrogen and air;
a fuel supply unit that supplies hydrogen to the stack unit;
an air supply unit that supplies air to the stack unit; and
a module unit having a used gas line that exhausts used gas generated from the fuel supply unit, a fuel supply line that supplies hydrogen provided from the fuel supply unit to the stack unit, and an air supply line that supplies air provided from the air supply unit to the stack unit, the used gas line, the fuel supply line, and the air supply line being sequentially arranged and integrally modularized.

2. The fuel cell system of claim 1, wherein the fuel supply line is positioned at a lower side of the used gas line, and the air supply line is positioned at a lower side of the fuel supply line.

3. The fuel cell system of claim 1, wherein the used gas line is positioned at a center, the fuel supply line surrounds an outer circumferential surface of the used gas line, and the air supply line surrounds an outer circumferential surface of the fuel supply line.

4. The fuel cell system of claim 1, wherein the module unit further comprises:
a first gas-liquid separation unit positioned adjacent to the used gas line, said first gas-liquid separation unit configured to remove moisture contained in hydrogen supplied to the stack unit from the fuel supply unit;
a second gas-liquid separation unit positioned adjacent to the first gas-liquid separation unit, said second gas-liquid separation unit configured to moisture contained in off-gas supplied to the fuel supply unit from the stack unit;
a first recollect line provided between the used gas line and the first gas-liquid separation unit; and
a second recollect line provided between the first gas-liquid separation unit and the second gas-liquid separation unit.

5. The fuel cell system of claim 1, wherein the module unit further comprises a heat exchanger positioned adjacent to the used gas line, said heat exchanger configured to exchange heat generated by the stack unit.

6. The fuel cell system of claim 1, wherein the module unit further comprises:
a first gas-liquid separation unit positioned adjacent a left side of the used gas line, said first gas-liquid separation unit configured to remove moisture contained in hydrogen supplied to the stack unit from the fuel supply unit;
a second gas-liquid separation unit positioned adjacent a left side to the first gas-liquid separation unit, said second gas-liquid unit configured to remove moisture contained in off-gas supplied to the fuel supply unit from the stack unit;
a heat exchanger positioned adjacent a right side of the used gas line, said heat exchanger configured to exchanged heat generated by the stack unit;
a first recollect line provided between the used gas line and the first gas-liquid separation unit; and
a second recollect line provided between the first gas-liquid separation unit and the second gas-liquid separation unit,
wherein the fuel supply line is positioned adjacent a lower side of the used gas line, and the air supply line is positioned adjacent a lower side of the fuel supply line.

7. A fuel cell system, comprising:
a stack unit that generates electricity by electrochemically reacting hydrogen and air;
a fuel supply unit that supplies hydrogen to the stack unit;
an air supply unit that suppliesair to the stack unit; and
a module unit having a used gas line that exhausts used gas generated from the fuel supply unit, a fuel supply line positioned adjacenta lower side of the used gas line that supplies hydrogen provided from the fuel supply unit to the stack unit, an air supply line positioned adjacent a lower side of the fuel supply line that supplies air provided from the air supply unit to the stack unit, and a heat exchanger closely arranged to the used gas line for exchanging heat generated from the stack unit,
wherein the used gas line, the fuel supply line, the air supply line, and the heat exchanger are integrally modularized.

8. The fuel cell system of claim 7, wherein the module unit further comprises:
a first gas-liquid separation unit positioned adjacent to the used gas line, that removes moisture contained in hydrogen supplied to the stack unit from the fuel supply unit;
a second gas-liquid separation unit positioned adjacent to the first gas-liquid separation unit, that removes moisture contained in off-gas supplied to the fuel supply unit from the stack unit;
a first recollect line provided between the used gas line and the first gas-liquid separation unit; and
a second recollect line provided between the first gas-liquid separation unit and the second gas-liquid separation unit.

9. A fuel cell system, comprising:
a stack unit that generates electricity by electrochemically reacting hydrogen and air;
a fuel supply unit that supplies hydrogen to the stack unit;
an air supply unit that supplies air to the stack unit; and
a module unit having a used gas line that exhausts used gas generated from the fuel supply unit, a fuel supply line that surrounds an outer circumferential surface of the used gas line that supplies hydrogen provided from the fuel supply unit to the stack unit, an air supply line that surrounds an outer circumferential surface of the fuel supply line that supplies air provided from the air supply unit to the stack unit, and a heat exchanger positioned adjacent to the used gas line that exchanges heat generated from the stack unit,
wherein the used gas line, the fuel supply line, the air supply line, and the heat exchanger are integrally modularized.

10. The fuel cell system of claim 9, wherein the module unit further comprises:
a first gas-liquid separation unit positioned adjacent to the used gas line, that removes moisture contained in hydrogen supplied to the stack unit from the fuel supply unit;
a second gas-liquid separation unit positioned adjacent to the first gas-liquid separation unit, that removes moisture contained in off-gas supplied to the fuel supply unit from the stack unit;
a first recollect line provided between the used gas line and the first gas-liquid separation unit; and
a second recollect line provided between the first gas-liquid separation unit and the second gas-liquid separation unit.
